(19) United States
(12) Patent Application Publication
(10) Pub. No.: US 2007/0057886 A1
(43) Pub. Date: Mar. 15, 2007

(54) Image decryption system

(75) Inventors: Mark T. Johnson, Veldhoven (NL); Pim T. Tuyls, Mol (BE); Thomas A.M. Kevenaar, Sterksei (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., BA Eindhoven (NL)

(21) Appl. No.: 10/574,449

(22) PCT Filed: Oct. 4, 2004
(86) PCT No.: PCT/IB04/51957

§ 371 Date: Apr. 4, 2006

(30) Foreign Application Priority Data
Oct. 7, 2003 (GB) 0323364.0

(51) Int. Cl. G09G 3/36

(52) U.S. Cl. 345/90

(57) ABSTRACT

A decryption device (2) is arranged for visually decrypting an encrypted image displayed on a display device (1) emitting polarized light. The decryption device (2) comprises a polarizing element (21), a liquid crystal display (23), and a further polarizing element (22), arranged such that the polarized light received from the display device (1) and incident on the polarizing element (21) may pass through the liquid crystal display (23) and the further polarizing element (22). The polarizing element (21) comprises a switchable polarizer capable of switching between a first, polarizing state and a second, nonpolarizing state. This allows the decryption device to be used as a stand-alone device which can also be used for other applications. The display device (1) is preferably also provided with a switchable polarizer (12).

The present invention relates to an image decryption system. More in particular, the present invention relates to a system for visually decrypting an encrypted image, the system comprising a display device for displaying the encrypted image, and a decryption device for visually decrypting the encrypted image displayed on the display device. The present invention also relates to a method of visually decrypting an encrypted image, a decryption device for visually decrypting an encrypted image and a display device for displaying an encrypted image.

It is well known to encrypt an image in order to prevent the image being recognized or to prevent its contents being read by unauthorized persons. One technique of encrypting an image is disclosed in, for example, European Patent Application EP 0 260 815. This technique, also known as visual cryptography, employs two patterns which are overlaid to produce a recognizable image. To this end, the original image is transformed into two randomized parts or patterns, neither of which contains any perceptible image information. One of these patterns is printed on a transparency or displayed on an at least partially transparent display to allow the patterns to be combined in the eye of the viewer.

This transformation of the original image, however, typically causes the number of image elements, also known as picture elements (pixels), to increase while the resolution decreases. Typically the encrypted image contains two times or, when the aspect ratio of the image is to be maintained, four times as many image elements as the original image.

International Patent Application WO 03/067797 (Philips) discloses a method and a device for reconstructing a graphical message which previously has been encrypted using visual cryptography. A display device (“client device”) and a decryption device are both provided with a liquid crystal display (LCD). Cells in a first (display device) liquid crystal display are activated if a bit in the encrypted message sequence represents ‘1’ and not activated if said bit represents ‘0’. Similarly, cells in a second (decryption device) liquid crystal display are activated if a corresponding bit in a key sequence represents ‘0’ and not activated if said bit represents ‘1’. The first and second displays are then superimposed and placed between polarization filters so as to visually reconstruct the graphical message.

This known method and device allow a very effective and high-resolution reconstruction of the original graphical message (that is, the encrypted image), without increasing the number of pixels in either of the randomized patterns. However, the known method and device have the disadvantage that the decryption device cannot be used separately as it relies on the polarization filters of the terminal: it cannot have polarization filters on both sides of its liquid crystal display as this would result in a polarizer being located between the two liquid crystal displays, thus undoing the light rotation effect of these displays. This seriously limits the practical applications of the decryption device.

In addition, the known method and device cannot easily be used with existing display devices. The known method requires the second liquid crystal display to be arranged between the first liquid crystal display and a polarization filter. To this end, a dedicated slot is provided in the terminal for inserting the decryption device. Alternatively, part of this polarization filter can be removed to allow the liquid crystal displays to be superimposed when no slot is provided. It will be clear, however, that existing display devices are typically not provided with such a slot or a partially removed polarization filter.

It is an object of the present invention to overcome these and other problems of the Prior Art and to provide a system for decrypting encrypted images using liquid crystal displays, which system allows both the display device and the decryption device to be used independently.

Accordingly, the present invention provides a system for visually decrypting an encrypted image, the system comprising a display device for displaying the encrypted image, the display device comprising a first polarizing element; a first liquid crystal display, and a second polarizing element; arranged such that light incident on the first polarizing element may pass through the first liquid crystal display and the second polarizing element, the system further comprising a decryption device for visually decrypting the encrypted image displayed on the display device, the decryption device comprising a third polarizing element; a second liquid crystal display; and a fourth polarizing element; arranged such that light received from the display device and incident on the third polarizing element may pass through the second liquid crystal display and the fourth polarizing element, wherein the third polarizing element comprises a switchable polarizer capable of switching between a first, polarizing state and a second, non-polarizing state.

By providing a polarizing element which can be switched between two states, one in which the element acts as a polarizer and one it which the polarizing effect is switched off, an extremely versatile decryption device is achieved. When used in conjunction with a display device, for example when visually decrypting images, the switchable polarizing element is switched off. When used in another application, for example viewing non-encrypted (“plain text”) images, the switchable polarizing element is switched on.

The switchable polarizing element further allows the display device to be provided with two polarizing elements. As one element can be switched off, it is no longer a problem when this element is positioned between the two liquid crystal displays.

In a first embodiment, the display device is designed according to the Prior Art mentioned above, having a slot for inserting the decryption device. In a second embodiment, however, the provision of such a slot is no longer necessary as the second polarizing element comprises a switchable polarizer capable of switching between a first, polarizing state and a second, non-polarizing state. That is, the display device's polarizing element facing the decryption device can be switched on or off. This allows the display device to be used both for displaying regular (non-encrypted) images with the second polarizing element being switched on, and for visually decrypting images in conjunction with a decryption device as defined above, with the second polarizing element being switched off. It will be understood that a display device according to the present invention still allows the use of a decryption device having only a single polarizing element, that is, a decryption device according to the Prior Art.

The switching of the switchable polarizing elements may be done manually but is preferably carried out automatically. In a preferred embodiment, sensors are provided in the display device and/or the decryption device for sensing the presence of the counterpart device and switching the switchable polarizing element or elements. These sensors may be optical, mechanical or electromagnetic.

Although the system of the present invention is referred to as a system for decrypting an encrypted image, it can also be considered a system for reconstructing a graphical message, the “reconstructing” being the decyphering and the “graphical message” being the encrypted image. In the present description of the invention it is assumed that the image has been encrypted using Visual Cryptography or a similar technique and that the encrypted image is one of two “shares”, neither of which discloses the image unless they are superimposed, although the present invention is not so limited.

The present invention further provides a display device for displaying an encrypted image, the display device comprising a first polarizing element; a first liquid crystal display; and a second polarizing element; arranged such that light incident on the first polarizing element may pass through the first liquid crystal display and the second polarizing element, wherein the second polarizing element comprises a switchable polarizer capable of switching between a first, polarizing state and a second, non-polarizing state.

Such a display device may be used both for visually decrypting images and for viewing non-encrypted images. Although the display device of the present invention may be provided with a slot for inserting a decryption device, this will typically not be necessary as the decryption device may be placed in front of the display device.

The present invention also provides a decryption device for visually decrypting an encrypted image displayed on a display device emitting polarized light, the decryption device comprising a third polarizing element; a second liquid crystal display; and a fourth polarizing element; arranged such that light received from the display device and incident on the third polarizing element may pass through the second liquid crystal display and the fourth polarizing element, wherein the third polarizing element comprises a switchable polarizer capable of switching between a first, polarizing state and a second, non-polarizing state.

Such a decryption device can be used as a stand-alone device for viewing (non-encrypted) images, as it has two polarizing elements, one on each side of the liquid crystal display. In addition, it may be used as a dedicated decryption device in conjunction with a suitable display device, as one of the polarizing elements may be switched off.

The present invention additionally provides a method of visually decrypting an encrypted image, the method comprising a first step of displaying the encrypted image on a display device comprising a first polarizing element; a first liquid crystal display; and a second polarizing element; arranged such that light incident on the first polarizing element may pass through the first liquid crystal display and the second polarizing element, the method comprising the further step of using a decryption device comprising a third polarizing element; a second liquid crystal display; and a fourth polarizing element, arranged such that light received from the display device and incident on the third polarizing element may pass through the second liquid crystal display and the fourth polarizing element, wherein the third polarizing element comprises a switchable polarizer capable of switching between a first, polarizing state and a second, non-polarizing state.

In the method of the present invention, the second polarizing element preferably comprises a switchable polarizer capable of switching between a first, polarizing state and a second, non-polarizing state.

The present invention will further be explained below with reference to exemplary embodiments illustrated in the accompanying drawings, in which:

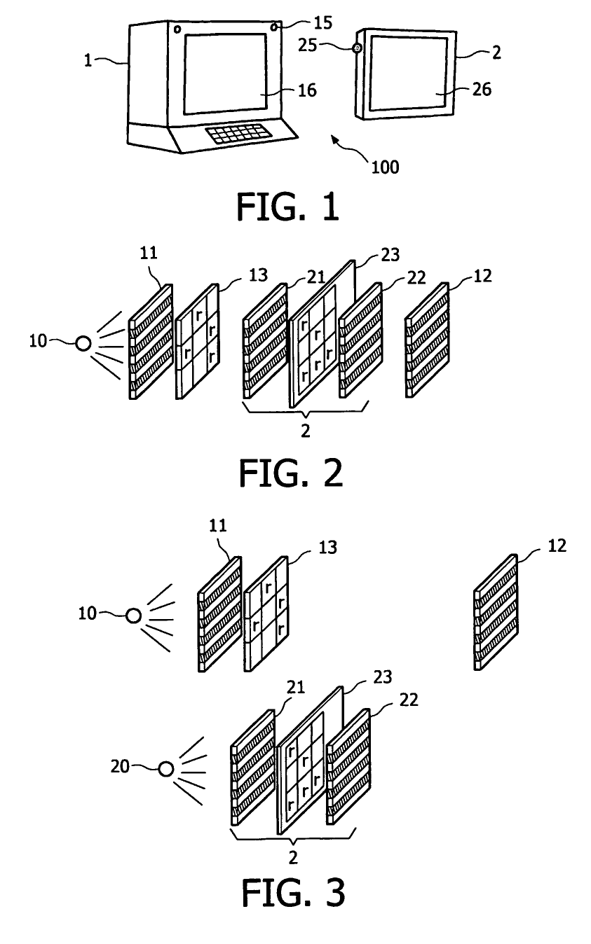

FIG. 1 schematically shows a system for visually decrypting images in accordance with the present invention.

FIG. 2 schematically shows a first embodiment of a display device and a decryption device according to the present invention.

FIG. 3 schematically shows the embodiment of FIG. 2 with the decryption device removed from the display device.

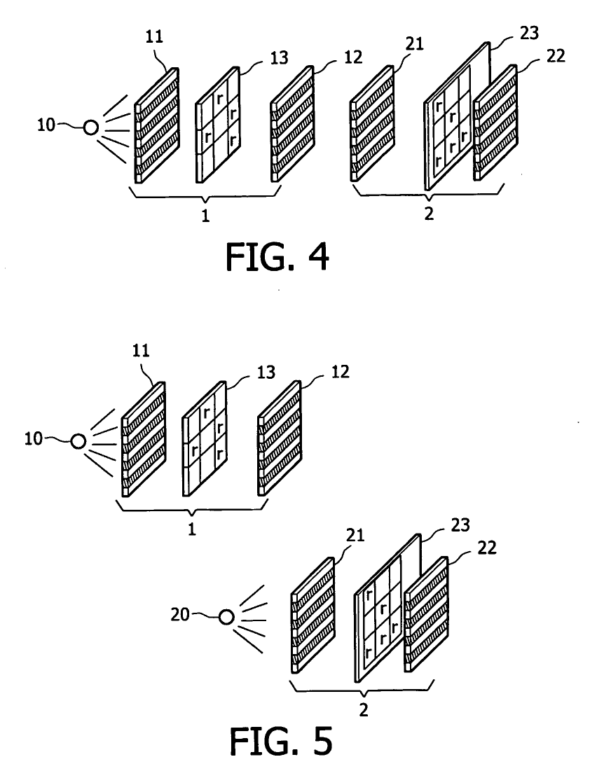

FIG. 4 schematically shows a second embodiment of a display device and a decryption device according to the present invention.

FIG. 5 schematically shows the embodiment of FIG. 4 with the decryption device removed from the display device.

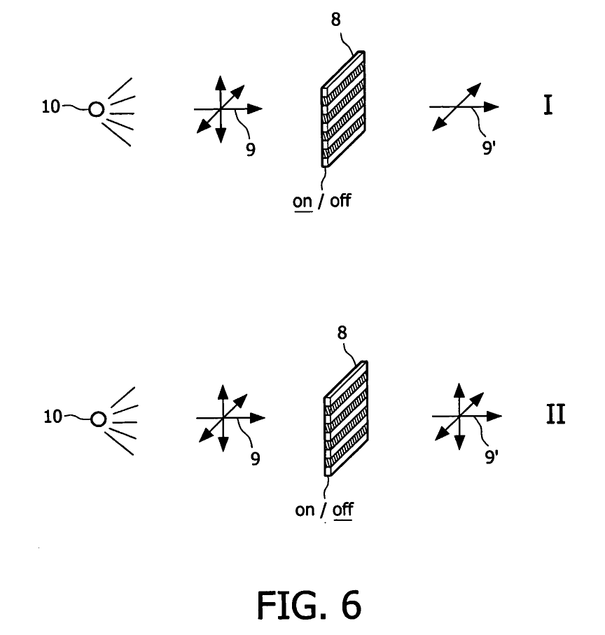

FIG. 6 schematically shows a switchable polarizer as used in the present invention.

The system 100 shown merely by way of non-limiting example in FIG. 1 comprises a display device (terminal) 1 and a decryption device 2. The terminal 1 may be a personal computer which preferably is connected to the Internet or another network such as a LAN (Local Area Network), an automatic teller machine (ATM) for carrying out financial transactions, or another type of terminal capable of displaying an image.

The terminal 1 may receive an image from a remote server (not shown) via the network. To preserve secrecy, the image is encrypted using visual cryptography: based upon the original image, two partial images or “shares” are made, neither of which contains any visible information on the original image. One of the shares is stored as a key in the decryption device 2, the other share is displayed on the terminal 1. The decryption device 2 has a transparent display 26 which allows both shares to be seen when the decryption device is placed in front of the display screen 16 of the terminal and thus to “decrypt” the encrypted image. The combined shares allow the user to recognize the original image. Reference is made to International Patent Application WO 03/067797 mentioned above, the entire contents of which are herewith incorporated in this document.

In the embodiment shown, the terminal 1 is provided with sensors 15 for sensing the presence of the decryption device 2. Preferably, the decryption device 2 is provided with sensors 25 which serve to sense the presence of the display terminal 1. The function of these sensors will later be explained with reference to FIGS. 4 and 5.

To provide a high-resolution image use is made of two liquid crystal displays and a set of polarizers, as schematically shown in FIG. 2. A light source 10 is accommodated in the terminal (display device) 1 which also comprises a first polarizer 11, a second polarizer 12 and a (first) liquid crystal display 13. A decryption device 2 comprises a third polarizer 21, a fourth polarizer 22 and a further (second) liquid crystal display 23. As can be seen, the decryption device 2 is inserted between the first liquid crystal display 13 and the fourth polarizer 22. It is noted that the fourth polarizer 22 is optional and only serves to allow the display device 1 to be used independently, that is, when the decryption device 2 is removed.

In FIG. 2, the light from the light source 10 passes through the first polarizer 11. As a result, the light incident on the first liquid crystal display 13 has a (for example) horizontal orientation. The light passes through the first liquid crystal display 13 and receives, dependent on the activation of the individual liquid crystal display elements, a selective rotation of 90° (indicated by “r” in FIG. 2). In a system according to the Prior Art mentioned above, the light would then pass through the second liquid crystal display 23, again selectively receiving a rotation of 90° in dependence on the activation of the individual liquid crystal display elements before passing through the second polarizer 12 which also has a (for example) horizontal orientation. It will be clear that light rotated twice over 90°, that is over 180°, will pass through the second polarizer 12, as will light which is not rotated at all, resulting in a light pixel (picture element). Light rotated only once, that is over 90°, will not be able to pass, resulting in a dark pixel.

As can be seen from FIG. 2, placing a (third) polarizer 21 between the first liquid crystal display and the second liquid crystal display would cause the arrangement to fail as all light rotated once (over 90°) by the first liquid crystal display will be blocked by this polarizer. This means that the decryption device 2 cannot be used independently, that is, it cannot be used without the display device 1 as its proper functioning depends on the presence of a polarizer between the light source and the (second) liquid crystal display.

In other words, both the display device 1 and the decryption device 2 require a polarizing element on either side of its respective liquid crystal display to function independently, but that would place a polarizer between the two liquid crystal displays, causing the combined arrangement to stop functioning.

The present invention provides a very simple and effective solution for this problem by using a switchable polarizer as the third polarizer 21. A switchable polarizer is an optical component which changes from a substantially non-polarizing (transparent) state to a substantially polarizing state. An example of a switchable polarizer is a layer of liquid crystal material which incorporates optically anisotropic dye molecules (a so-called “guest-host” liquid crystal system). The guest-host layer is situated between two transparent electrodes. When no voltage is applied to the electrodes, all of the dye molecules (and liquid crystal molecules) are randomly oriented, and light passes through the layer without becoming polarized. If, however, a voltage is applied to the electrodes, the liquid crystal molecules rotate into a preferred direction rotating the dye molecules as well. The light passing through the layer becomes polarized by the ordered dye molecules.

The switchable polarizer 21 can be switched off when the decryption device is used in conjunction with the terminal 1, resulting in the absence of any polarization between the first liquid crystal display 13 and the second liquid crystal display 23. However, the switchable polarizer 21 can be switched on when the decryption device is used independently, for example for viewing non-encrypted (“plain text”) images. The decryption device of the present invention can therefore also be used as a regular LCD viewing device. This is schematically shown in FIG. 3, where the decryption device 2 (polarizers 21 and 22 and liquid crystal display 23) has been removed from the display device 1. As can be seen, both devices have a single polarizer on either side of their respective liquid crystal display, allowing them to be used independently.

A preferred embodiment of the present invention is schematically shown in FIGS. 4 and 5. In this embodiment, the decryption device 2 is not placed between the first liquid crystal display 13 and the second polarizer 12 of the display device, in the display device, but is placed in front of the second polarizer 12, outside the display device 1. As can be seen, this results in two polarizers (12 and 21) being located between the first liquid crystal display 13 and the second liquid crystal display 23. As discussed above, this arrangement would normally cause the visual decryption to fail. In accordance with this embodiment of the present invention, however, both the third polarizer 12 and the fourth polarizer 21 are switchable polarizers, allowing these polarizers to be switched off when the decryption device 2 is placed in front of the display screen of the display device 1. As a result, substantially no light rotation occurs between the first liquid crystal display 13 and the second liquid crystal display 23 and the arrangement functions as desired.

When the decryption device 2 is removed from the display device 1, as illustrated in FIG. 5, the switchable polarizers 12 and 21 are switched on, allowing the display device 1 and the decryption device 2 to be used independently.

It is noted that the switchable polarizers may be switched on and off manually, for example by pressing a suitable button on the respective device, or automatically, for example in response to detection elements (including sensors 15 and 25 in FIG. 1). Such detection elements may comprise mechanical, optical and/or electromechanical sensors capable of sensing the presence of the counterpart device. The detection elements may further comprise signal processing means for processing sensor signals. In this way the switchable polarizers may be operated without any intervention from the user.

In an advantageous embodiment the detection means of the display device and the detection means of the decryption device may exchange messages to verify the authenticity of the devices, it can be envisaged that the switchable polarizers are only switched off when the authenticity has been proven.

The decryption device 2 contains a key (partial image or “share”) which determines the activation of the individual elements of the second liquid crystal display 23. Preferably not a single key but a set of keys is stored in the decryption device to enhance the security of the visual cryptography system. As will be clear to those skilled in the art, suitable memory circuits may be provided for this purpose. In addition, the decryption device 2 may comprise further components, such as a PRG (Pseudo Random Generator) for generating random numbers.

The schematic illustration of FIG. 6 shows how a switchable polarizer may affect light produced by a light source 10. The light 9 is originally not polarized and has no specific orientation. In a first mode 1, the switchable polarizer 8 is switched on and polarizes the light 9. In the example shown, the direction of polarization is horizontal. The light 9′ emanating from the polarizer 8 is horizontally polarized. In a second mode 11, however, the polarization is switched off and the light 9′ emanating from the polarizer 8 is not polarized and has no specific orientation.

The present invention is based upon the insight that providing at least one switchable polarizing element in a system for visual cryptography allows a polarizing element to be placed between two liquid crystal layers while preserving their light rotating properties used for visual decryption. The present invention benefits from the further insight that a switchable polarizing element allows the decryption device, and possibly also the display device, to be used independently.

The present invention is of particular use for carrying out secure transactions, for example (internet) banking or internet shopping. In addition, the decryption device of the present invention can also be used as a viewer for independently viewing images such as pictures, movies, videos and the like if suitable circuitry is provided for controlling the liquid crystal display in accordance with those images. The decryption device of the present invention is preferably a portable, hand-held device which may be carried by a user. Such a portable device is also very suitable for ATM (Automatic Teller Machine) transactions in which a high level of security is desired.

It is noted that although the present invention has been discussed with reference to liquid crystal displays, the invention is not so limited and that any other transparent display providing selective polarization could be used.

It is further noted that any terms used in this document should not be construed so as to limit the scope of the present invention. In particular, the words “comprise(s)” and “comprising” are not meant to exclude any elements not specifically stated. Single (circuit) elements may be substituted with multiple (circuit) elements or with their equivalents.

It will be understood by those skilled in the art that the present invention is not limited to the embodiments illustrated above and that many modifications and additions may be made without departing from the scope of the invention as defined in the appending claims.

1. A system (100) for visually decrypting an encrypted image, the system comprising a display device (1) for displaying the encrypted image, the display device comprising:
a first polarizing element (11);
a first liquid crystal display (13); and
a second polarizing element (12);
arranged such that light incident on the first polarizing element (11) may pass through the first liquid crystal display (13) and the second polarizing element (12),
the system further comprising a decryption device (2) for visually decrypting the encrypted image displayed on the display device (1), the decryption device (2) comprising:
a third polarizing element (21);
a second liquid crystal display (23); and
a fourth polarizing element (22);
arranged such that light received from the display device (1) and incident on the third polarizing element (21) may pass through the second liquid crystal display (23) and the fourth polarizing element (22),
wherein the third polarizing element (21) comprises a switchable polarizer capable of switching between a first, polarizing state (I) and a second, non-polarizing state (II).

2. The system according to claim 1, wherein the second polarizing element (12) comprises a switchable polarizer capable of switching between a first, polarizing state (I) and a second, non-polarizing state (II).

3. The system according to claim 1, wherein the switching of the switchable polarizing elements(s) is carried out automatically.

4. The system according to claim 3, wherein sensors are provided in the display device (1) and/or the decryption device (2) for sensing the presence of the counterpart device and switching the switchable polarizing element (21) or elements (21, 12).

5. A display device (1) for displaying an encrypted image, the display device comprising:
a first polarizing element (11);
a first liquid crystal display (13); and
a second polarizing element (12);
arranged such that light incident on the first polarizing element (11) may pass through the first liquid crystal display (13) and the second polarizing element (12),
wherein the second polarizing element (12) comprises a switchable polarizer capable of switching between a first, polarizing state (I) and a second, non-polarizing state (II).

6. The display device according to claim 5, further comprising detection means (15) for detecting the presence of the counterpart device and switching off the first polarizing element (12) in response thereto.

7. A decryption device (2) for visually decrypting an encrypted image displayed on a display device (1) emitting polarized light, the decryption device (2) comprising:
a third polarizing element (21);
a second liquid crystal display (23); and
a fourth polarizing element (22);
arranged such that light received from the display device (1) and incident on the third polarizing element (21) may pass through the second liquid crystal display (23) and the fourth polarizing element (22),
wherein the third polarizing element (21) comprises a switchable polarizer capable of switching between a first, polarizing state (I) and a second, non-polarizing state (II).

8. The decryption device according to claim 7, further comprising detection means (25) for detecting the presence of a display device (1) and switching off the third polarizing element (21) in response thereto.

9. The decryption device according to claim 7, further comprising a set of keys and/or a pseudo random generator.

10. A method of visually decrypting an encrypted image, the method comprising a first step of displaying the encrypted image on a display device (1) comprising:
a first polarizing element (11);
a first liquid crystal display (13); and
a second polarizing element (12);
arranged such that light incident on the first polarizing element (11) may pass through the first liquid crystal display (13) and the second polarizing element (12),
the method comprising the further step of using a decryption device (2) comprising:
a third polarizing element (21);
a second liquid crystal display (23); and
a fourth polarizing element (22);
arranged such that light received from the display device (1) and incident on the third polarizing element (21) may pass through the second liquid crystal display (23) and the fourth polarizing element (22),
wherein the third polarizing element (21) comprises a switchable polarizer capable of switching between a first, polarizing state (I) and a second, non-polarizing state (II).

11. The method according to claim 10, wherein the second polarizing element (12) comprises a switchable polarizer capable of switching between a first, polarizing state (I) and a second, non-polarizing state (II).
